(19) United States
(12) Patent Application Publication
(10) Pub. No.: US 2019/0389238 A1
(43) Pub. Date: Dec. 26, 2019

(54) JIG FOR IMAGE FORMING APPARATUS, IMAGE FORMING SYSTEM, AND JIG SET FOR IMAGE FORMING APPARATUS

(71) Applicants: Mitsutaka Nakamura, Kanagawa (JP); Yasunari Harada, Kanagawa (JP)

(72) Inventors: Mitsutaka Nakamura, Kanagawa (JP); Yasunari Harada, Kanagawa (JP)

(73) Assignee: Ricoh Company, Ltd., Tokyo (JP)

(21) Appl. No.: 16/410,506

(22) Filed: May 13, 2019

(30) Foreign Application Priority Data
Jun. 22, 2018 (JP) 2018-118751

(51) Int. Cl. B43L 7/027; B41J 3/36

(52) U.S. Cl. CPC B43L 7/027; B41J 3/36

(57) ABSTRACT

A jig for an image forming apparatus that forms an image on a recording medium while being moved in a scanning direction includes a first portion extending in a first direction to be aligned with the scanning direction and a second portion extending in a second direction orthogonal to the first direction. The first portion includes an apparatus positioning reference extending in the first direction, and the apparatus positioning reference is a reference in positioning the image forming apparatus in an orthogonal direction orthogonal to the scanning direction. The second portion includes a jig positioning reference as a reference in positioning the jig relative to the recording medium in the orthogonal direction.

### CROSS-REFERENCE TO RELATED APPLICATION

This patent application is based on and claims priority pursuant to 35 U.S.C. § 119(a) to Japanese Patent Application No. 2018-118751, filed on Jun. 22, 2018, in the Japan Patent Office, the entire disclosure of which is hereby incorporated by reference herein.

### BACKGROUND

### Technical Field

The present disclosure generally relates to a jig for an image forming apparatus, an image forming system, and a jig set for the image forming apparatus.

### Description of the Related Art

There are jigs for positioning of a mobile image forming apparatuses. Such a jig includes an apparatus positioning reference for positioning of the mobile image forming apparatus in a direction orthogonal to a scanning direction of the mobile image forming apparatus. In image formation, a user moves the mobile image forming apparatus in the scanning direction on a recording medium while regulating the position of the mobile image forming apparatus with the apparatus positioning reference.

### SUMMARY

An embodiment of this disclosure provides a jig for an image forming apparatus that forms an image on a recording medium while being moved in a scanning direction. The jig includes a first portion extending in a first direction to be aligned with the scanning direction and a second portion extending in a second direction orthogonal to the first direction. The first portion includes an apparatus positioning reference extending in the first direction, and the apparatus positioning reference is a reference in positioning the image forming apparatus in an orthogonal direction orthogonal to the scanning direction. The second portion includes a jig positioning reference as a reference in positioning the jig relative to the recording medium in the orthogonal direction.

Another embodiment provides a jig set for an image forming apparatus. The jig set includes the jig described above and an attachment to be attached to the image forming apparatus. The attachment includes an inserted portion inserted into the apparatus positioning reference configured to contact the inserted portion from both sides in the orthogonal direction, to regulate the position of the image forming apparatus in the orthogonal direction.

Another embodiment provides an image forming system that includes an image forming apparatus configured to form an image on a recording medium while being moved in the scanning direction; and the jig described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view illustrating a handheld mobile printer (hereinafter “handheld printer”) according to an embodiment, as viewed from obliquely upward;

FIG. 2 is a perspective view illustrating the handheld printer in motion;

FIG. 3 is a perspective view illustrating the handheld printer with an upper unit thereof opened horizontally against a lower unit thereof;

FIG. 4 is a bottom view of the handheld printer as viewed from a recording side;

FIG. 5 is a block diagram illustrating a part of an electric circuit of the handheld printer;

FIG. 6 is a perspective view illustrating a jig for a handheld printer, according to an embodiment;

FIG. 7 is a plan view illustrating how the handheld printer produces letter images such as an occasion type or a sender name of a gift, using the jig, on an A4-sized wrapping sheet with a gift ribbon image printed on the sheet;

FIG. 8 is a perspective view illustrating a bottom face of the jig;

FIG. 9 is an enlarged view illustrating sheet positioning members of the jig;

FIG. 10 is a perspective view illustrating the handheld printer positioned at a scanning start position (home position) in a scanning direction placed relative to the jig;

FIG. 11 is an enlarged view illustrating an attachment attached to the handheld printer;

FIG. 12 is a plan view illustrating the jig set on the wrapping sheet;

FIG. 13 is a plan view illustrating the handheld printer set relative to the jig;

FIG. 14 is a perspective view for explaining an operation of positioning the handheld printer at the home position;

FIG. 15 is a plan view illustrating a state where the handheld printer produces letter images such as a sender name on the wrapping sheet in manual scanning;

FIG. 16 illustrates a case where, after a letter image representing an occasion type is formed on the wrapping sheet, letter images representing names of two senders are formed in two lines in the Y-axis direction orthogonal to the scanning direction;

FIG. 17 is a plan view illustrating the jig set on the wrapping sheet;

FIG. 18 illustrates a case where, after a letter image representing an occasion type is formed, the jig is set on the wrapping sheet so as to produce the letter images representing the two senders at a targeted position thereof;

FIG. 19A is a perspective view illustrating the handheld printer with the attachment removed, being set at the home position relative to the jig in the scanning direction;

FIG. 19B is a perspective view illustrating the handheld printer with the attachment attached, being set at the home position relative to the jig in the scanning direction;

FIG. 20 is a plan view illustrating a case of forming the letter image representing the occasion type on a strip-shaped wrapping sheet; and

FIG. 21 is a plan view illustrating a case where an image formation start position indicator is configured to indicate a position of a recording section of the handheld printer in the scanning direction when the handheld printer is set at the home position.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, descriptions are given below of a handheld mobile inkjet printer (hereinafter simply referred to as “handheld printer”) that is a mobile image forming apparatus, a jig for the handheld printer (hereinafter simply referred to as “jig”), and a mobile image forming system including the handheld printer and the jig, as embodiments of the present disclosure. As used herein, the singular forms “a”, “an”, and “the” are intended to include the plural forms as well, unless the context clearly indicates otherwise.

First, a basic configuration of the handheld printer according to the present embodiment is described.

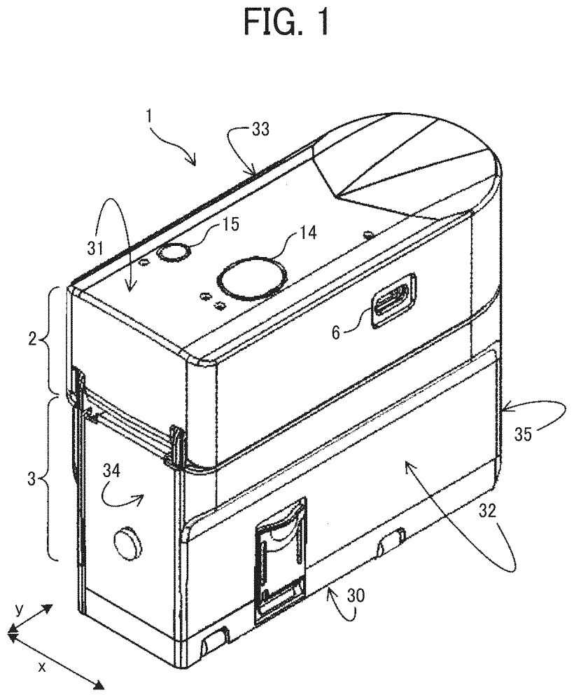

FIG. 1 is a perspective view illustrating an exterior of a handheld printer 1 according to the present embodiment, as viewed obliquely from above.

The handheld printer 1 illustrated in FIG. 1 includes an upper unit 2 and a lower unit 3.

The handheld printer 1 as a whole is shaped like a rectangular parallelepiped. In a scanning direction, that is, a printing direction indicated by arrow x in FIG. 1 (X-axis direction), the handheld printer has such a width that a user can grasp the handheld printer with a palm.

The housing of the handheld printer 1 includes a recording side 30, an upper side 31 opposite the recording side 30, a left side 32 facing in a direction indicated by arrow x. On the recording side 30, a recording section (an image forming section) of an inkjet head described later faces a recording medium.

The handheld printer 1 also includes a right side 33 facing in the scanning direction, a rear side 34 facing in a direction indicated by arrow y orthogonal to the scanning direction, a front side 35 facing in the direction orthogonal to the scanning direction.

In the description below, “orthogonal direction” represents the direction orthogonal to the scanning direction of the handheld printer 1 and along the surface of the recording medium, unless otherwise specified.

FIG. 1 illustrates the handheld printer 1 being in such a posture that the recording side 30 (i.e., a bottom face in FIG. 1) is faced vertically down and the upper side 31, which is opposite the recording side 30, is faced vertical up.

A print button 14 and a power button 15 are disposed within an outer edge (within a frame) of the upper side 31.

The left side 32 of the upper unit 2 includes a universal serial bus (USB) connection port 6.

The USB connection port 6 is a port for connecting a USB cable.

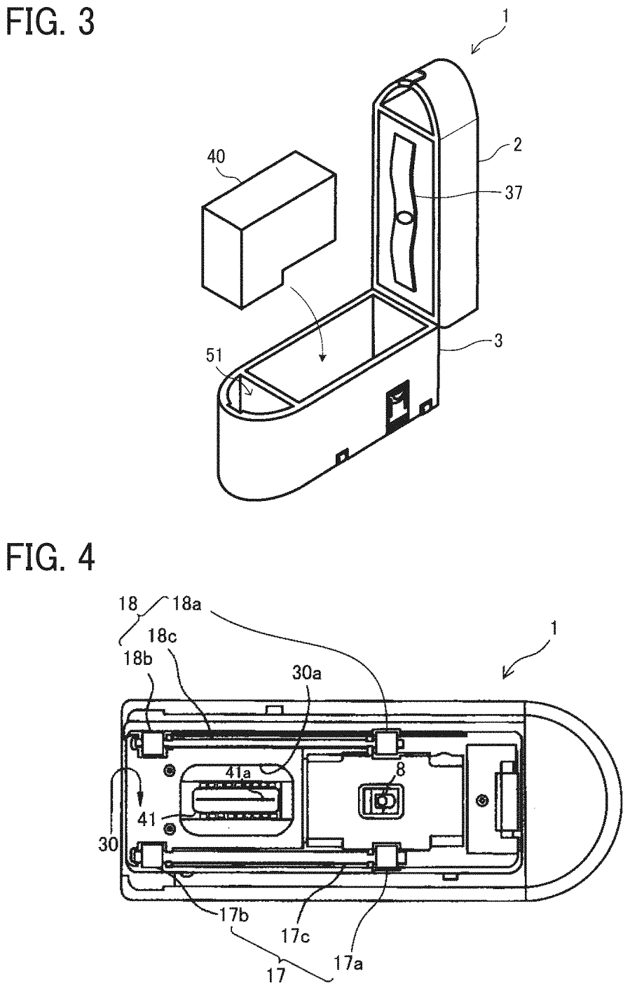

The handheld printer 1 is provided with a rechargeable battery 51 (illustrated in FIG. 3) mounted therein. The rechargeable battery 51 can be charged when electric power is supplied thereto from an external power supply via the USB cable connected to the USB connection port 6.

The user can hold down the power button 15 for a while to switch on and off the power of the handheld printer 1.

With the power turned on, a control board mounted in the upper unit 2 of the handheld printer 1 can acquire image information by Bluetooth (registered trademark) communication with external devices, e.g., a smartphone.

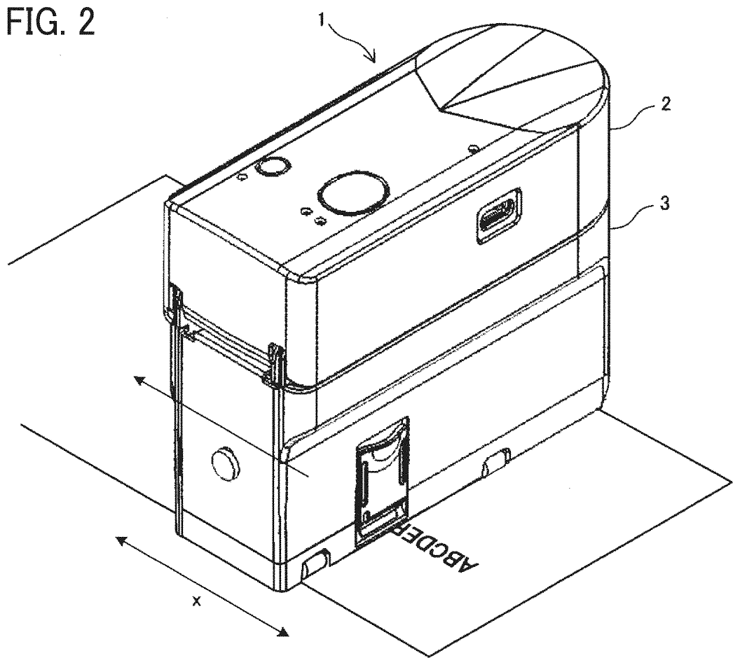

After the user places the handheld printer 1 on the surface of a recording medium with the recording side 30 facing the recording medium, the user presses the print button 14 once and moves the handheld printer 1 in the scanning direction (indicated in direction x as illustrated in FIG. 2), thus forming an image on the recording medium.

The handheld printer 1 can form an image on the surface of the recording medium both when the handheld printer 1 is moved forward in the scanning direction (indicated by arrow x) by the user and when the handheld printer 1 is moved backward in the scanning direction.

The recording medium is not limited to paper, such as paper sheets, but includes any medium on which an image is recordable, for example, overhead projector (OHP) sheets, cloth, cardboards, packaging containers, glass, and substrates.

FIG. 3 is a perspective view of the handheld printer 1 in a state in which the upper unit 2 is opened with respect to the lower unit 3.

As illustrated in FIG. 3, the upper unit 2 is held by the lower unit 3 to open and close with respect to the lower unit 3.

The battery 51 to supply power to each device of the handheld printer 1 is housed in an inner space of the lower unit 3.

As illustrated in FIG. 3, an inkjet head 40, that is, an ink cartridge, includes the recording section and an ink tank combined into a single unit and is removable from the lower unit 3 of the handheld printer 1.

At this time, the recording section to discharge ink droplets is faced down in the vertical direction.

The inkjet head 40 discharges ink droplets from the recording section to record an image on a recording medium.

On the inner face of the upper unit 2, a head-pressing flat spring 37 to press and hold the inkjet head 40 mounted in the lower unit 3 is attached.

In the handheld printer 1, since the battery 51 is disposed on a side of the inkjet head 40 in the lower unit 3, the height of the handheld printer 1 is smaller compared with a configuration in which the battery 51 is disposed above the inkjet head 40.

Such placement lowers the position of the center of gravity of the handheld printer 1, thus preventing the handheld printer 1 from falling over while being moved.

FIG. 4 is a bottom view of the handheld printer as viewed from the recording side.

In FIG. 4, the recording side 30 of the handheld printer 1 includes an opening 30a to expose the recording section 41 of the inkjet head 40 mounted in the lower unit 3 (FIG. 3) to the outside.

The recording section 41 includes a plurality of discharge nozzles 41a and is capable of discharging ink droplets separately from the respective discharge nozzles 41a as actuators (piezoelectric elements) are driven.

The recording section 41 is a region inside (on the side of the discharge nozzles 41a) a plurality of inner leads surrounding the discharge nozzles 41a along the surface of the substrate of the inkjet head 40.

In the handheld printer 1, the area of the recording section 41 on the substrate is painted white to be clearly distinguished from the surrounding black area.

In other words, the white area is a mark representing the recording section 41.

The shape of the mark is rectangular as illustrated in the drawing.

As a driving source to discharge ink, the inkjet head 40 employs, for example, electromechanical transducer element (piezoelectric actuators) including lamination-type piezoelectric elements or thin-film-type piezoelectric elements, or electrostatic actuators including electrothermal transducer elements, such as heat element, made of diaphragms and opposed electrodes.

The ink “liquid” discharged from the discharge nozzles 41a of the recording section 41 is not particularly limited as long as the liquid has a viscosity and a surface tension that can be discharged from the discharge nozzles 41a. However, it is preferable that the viscosity is 30 mPa·s or less under ordinary temperature and pressure or by heating or cooling.

Specifically, the term “liquid” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant.

Such a solution, a suspension, or an emulsion can be used for, e.g., inkjet ink, surface treatment solution, a liquid for forming components of an electronic element or a light-emitting element or a resist pattern of an electronic circuit, or a material solution for three-dimensional fabrication.

A position detection sensor 8 as a detector to detect the position of the handheld printer 1 on the recording medium, a first rotatable roller portion 17a, a second roller portion 17b, a first roller portion 18a, and a second roller portion 18b are disposed inside the outer edge of the recording side 30.

When the user moves the handheld printer 1 in the scanning direction, the four roller portions contacting the surface of the recording medium rotate like tires.

Owing to such roller mechanism, the user can advance the handheld printer 1 straight in the scanning direction.

At this time, only the four roller portions of the handheld printer 1 are in contact with the surface of the recording medium, and the recording side 30 is not in contact with the surface of the recording medium.

Therefore, a constant distance can be maintained between the recording section 41 of the inkjet head 40 and the surface of the recording medium, thus forming a desired high-quality image.

The position detection sensor 8 is a sensor to detect the distance to the surface of the recording medium, the surface state (for example, asperities) of the recording medium, and the distance by which the handheld printer 1 has traveled. The position detection sensor 8 is similar to a sensor used for, for example, an optical mouse (a pointing device) of a personal computer.

The position detection sensor 8 irradiates, with light, a place (recording medium) where the position detection sensor 8 is placed and reads the state of the place as a “pattern”.

The position detection sensor 8 sequentially detects how the “pattern” moves relative to the movement of the position detection sensor 8, to calculate the amount of movement.

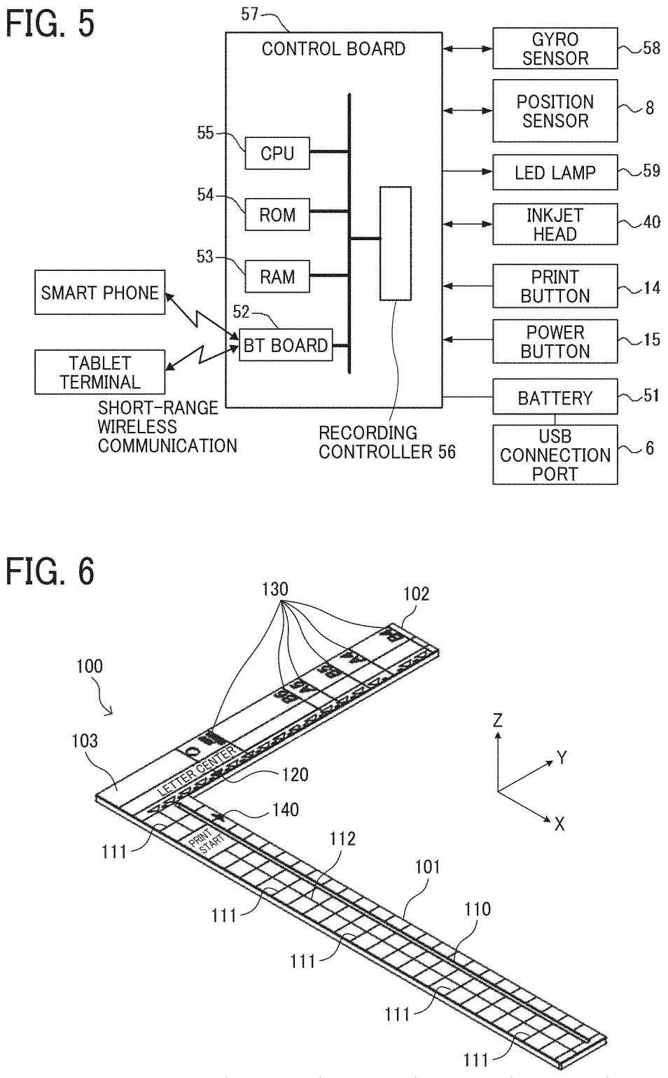

FIG. 5 is a block diagram illustrating a portion of an electric circuit of the handheld printer 1.

A control board 57 includes a central processing unit (CPU) 55 that performs various arithmetic processing and program execution, a Bluetooth (registered trademark) board (BT board) 52 for near field communication, a random access memory (RAM) 53 that temporarily stores data, a read-only memory (ROM) 54, and a recording controller 56.

The control board 57 is secured at a position on the back side of the USB connection port 6 (illustrated in FIG. 1) in a hollow space of the upper unit 2 (illustrated in FIG. 1).

The BT board 52 performs data communication by Bluetooth communication with an external device, such as a smartphone or a tablet terminal.

The ROM 54 stores, for example, firmware for hardware control of the handheld printer 1 and drive waveform data of the inkjet head 40.

The recording controller 56 executes data processing for driving the inkjet head 40 and generates drive waveforms.

The control board 57 is electrically connected to a gyro sensor 58, the position detection sensor 18, a light emitting diode (LED) lamp 59, the inkjet head 40, the print button 14, the power button 15, the battery 51, and the like.

The gyro sensor 58 detects the tilt and rotation angle of the handheld printer 1 and transmits the result of detection to the control board 57.

The LED lamp 59 is disposed inside an exterior cover made of a light transmissive material of the print button 14 and makes the print button 14 luminous.

When the power button 15 is pressed to turn on the power of the handheld printer 1, power is supplied to each module. The CPU 55 initiates startup according to the program stored in the ROM 54 and loads the program and each data in the RAM 53.

When data of an image to be formed is received from an external device by Bluetooth communication, the recording controller 56 generates a drive waveform corresponding to the image data.

The discharge of ink from the inkjet head 40 is controlled to form an image corresponding to the position on the surface of the recording medium detected by the position detection sensor 8.

In response to acquisition of image data via Bluetooth communication from an external device, the control board 57 illustrated in FIG. 5 causes the LED lamp 59 to blink so that the light transmissive print button 14, which transmits light, becomes luminous and blinks.

Seeing such blinking, the user knows that the acquisition of the image data by the handheld printer 1 has ended.

Then, the user places the handheld printer 1 on the recording medium and presses the print button 14.

Meanwhile, as the control board 57 starts blinking of the LED lamp 59, the control board 57 waits for pressing of the print button 14.

When the print button 14 is pressed, the control board 57 causes the LED lamp 59 to keep emitting light so that the print button 14 continuously emits light.

Seeing the continuous light emission, the user starts moving (manual scanning) the handheld printer 1 in the scanning direction.

Finishing moving (manual scanning) of the handheld printer 1, the user picks up the handheld printer 1 from the recording medium and places the handheld printer 1 on a table or the like.

When the handheld printer 1 is picked up from the recording medium, the position detection sensor 8 does not detect the position.

At the timing when the position detection sensor 8 no longer detects the position, the control board 57 turns off the LED lamp 59 and stops lighting of the print button 14. Seeing the stop of lighting, the user can know that the operation of the handheld printer 1 for printing has ended.

It is not necessary to keep pushing the print button 14 while the user moves (manual scanning) the handheld printer 1.

Once the print button 14 is pushed and released before the moving of the handheld printer 1, the image forming operation based on the detection result by the position detection sensor 8 is continued until the end of the image formation or end of the position detection by the position detection sensor 8.

Next, descriptions are given below of a jig configuration according to the present embodiment.

FIG. 6 is a perspective view illustrating an exterior of a jig 100 according to the present embodiment, as viewed obliquely from above.

According to the present embodiment, the jig 100 includes an orthogonal-direction positioning member 101 and a sheet positioning member 102, both of which are shaped like long plates and combined together (may be molded together) into a single piece so that relative positions thereof are fixed. The orthogonal-direction positioning member 101 extends in the scanning direction of the handheld printer 1 (X-axis direction), and the sheet positioning member 102 extends in the direction (Y-axis direction) orthogonal to the scanning direction of the handheld printer 1.

Specifically, the jig 100 is shaped like a character “L”, with one end of the orthogonal-direction positioning member 101 and one end of the sheet positioning member 102 are jointed together in a fixing member 103, like an L-shaped ruler.

A base of the jig 100 is preferably made of a light-transmissive material and transparent, so that a portion of the sheet (the recording medium, described later) overlapped with the jig 100 can be visually recognized through the jig 100.

In the present embodiment, the apparatus positioning reference is the groove 110 into which the projection of the handheld printer 1 is inserted. However, the apparatus positioning reference is not limited to the groove 110 but can be any structure that contacts the projection (an inserted portion described later) of the handheld printer 1 from both sides in the orthogonal direction, thereby retaining the position of the handheld printer 1 in the orthogonal direction.

Although the apparatus positioning reference according to the present embodiment is configured to inhibit the displacement of the handheld printer 1 to both sides in the orthogonal direction, the apparatus positioning reference can be configured to inhibit the displacement of the handheld printer 1 to one side in the orthogonal direction. For example, in the case in which the user moves the handheld printer 1 (for manual scanning) with a side (in particular, the rear side 34) of the handheld printer 1 pressed against a side face (facing in the orthogonal direction) of the orthogonal-direction positioning member 101, the side face of the orthogonal-direction positioning member 101 functions as the apparatus positioning reference.

Further, on the orthogonal-direction positioning member 101 of the jig 100 according to the present embodiment, sheet reference lines 111 are drawn, as at least one orthogonal-direction reference line, extending along the orthogonal direction (Y-axis direction). The sheet reference lines 111 are printed on the base of the jig 100. With the sheet reference lines 111, the user can set the jig 100 on the sheet so that a reference line segment on the sheet extending in the orthogonal direction (for example, a line segment drawn on the sheet or an end of the sheet, extending in the orthogonal direction) is parallel to the sheet reference lines 111 on the jig 100. Such setting can inhibit askew image formation on the sheet.

Further, on the orthogonal-direction positioning member 101 of the jig 100 according to the present embodiment, a sheet reference line 112 is drawn, as at least one scanning-direction reference line extending along the scanning direction (X-axis direction). The sheet reference lines 112 are printed on the base of the jig 100. With the sheet reference lines 112, the user can set the jig 100 on the sheet so that a reference line segment on the sheet extending in the scanning direction (for example, a line segment drawn on the sheet, or an end of the sheet, extending in the scanning direction) is parallel to the sheet reference lines 112 on the jig 100. Such setting can inhibit askew image formation on the sheet.

Meanwhile, the sheet positioning member 102 of the jig 100 according to the present embodiment includes references for determining the position of the jig 100 (i.e., jig positioning references) relative to the sheet in the Y-axis direction orthogonal to the scanning direction. In the present embodiment, the jig positioning references are indications of predetermined reference portions on the sheet, that is, a recording medium (i.e., a medium position indication) in the orthogonal direction. In the present embodiment, an end of the sheet in the orthogonal direction serves as the reference portion on the sheet, and the medium position indications are sheet end indications 130 indicating the end position of the sheet in the orthogonal direction. The sheet end indications 130 are printed on the base of the jig 100.

In the present embodiment, as illustrated in FIG. 6, the sheet end indications 130 are disposed at different positions in the Y-axis direction orthogonal to the scanning direction different in distance from the groove 110 in the orthogonal direction. The positions of the sheet end indications 130 different in the orthogonal direction are set, respectively, corresponding to a plurality of predetermined sheet sizes different in width in the orthogonal direction. Specifically, in a state in which the jig 100 is positioned on the sheet so that an end (the reference portion on the sheet) of each of the predetermined sheet sizes are aligned with the corresponding sheet end indication 130, the position of the recording section 41 of the handheld printer 1 in the orthogonal direction is positioned at a predetermined target position on the sheet.

In the jig 100 according to the present embodiment, the position of the sheet end indication 130 is set such that the predetermined target position on the corresponding sheet is a center position of the sheet in the orthogonal direction. In other words, the position of each sheet end indication 130 in the direction orthogonal to the scanning direction is set so that an image is formed at the center of the sheet in the orthogonal direction when an end (the reference portion) of the corresponding size sheet is aligned with the sheet end indication 130. For example, the distance from the sheet end indication 130 to an image formation position on the sheet positioning member 102 is the half the length of corresponding sheet size in the orthogonal direction, and the image formation position is determined by the groove 110 serving as the apparatus positioning reference.

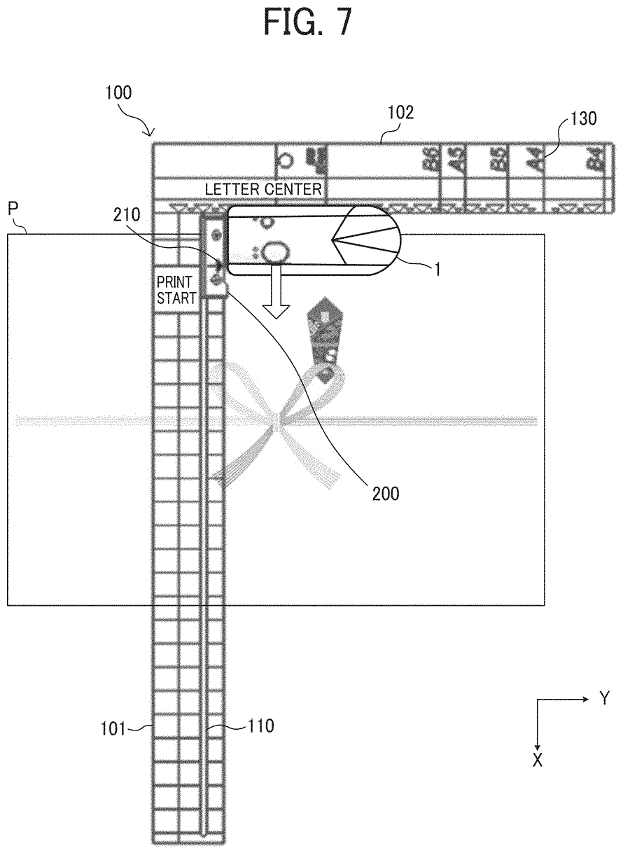

FIG. 7 is a plan view illustrating the jig 100 placed on an A4-sized wrapping sheet P on which a gift ribbon is printed. On the wrapping sheet P, letters (a letter image) representing a sender name can be printed with the handheld printer 1.

In the example illustrated in FIG. 7, the center position of the wrapping sheet P in the Y-axis direction orthogonal to the scanning direction is the target position at which the letter image (e.g., the sender name) is printed. In this case, the user first places the jig 100 on the wrapping sheet P so that one end of the wrapping sheet P in the orthogonal direction matches the sheet end indication 130, corresponding to the A4 size, on the sheet positioning member 102 of the jig 100.

The user holds the jig 100 with one hand so that the jig 100 does not move with respect to the wrapping sheet P. The user holds the handheld printer 1 with the other hand and positions the handheld printer 1 relative to the jig 100 so that the projection of the handheld printer 1 is inserted in the groove 110 in the orthogonal-direction positioning member 101 of the jig 100. After setting the handheld printer 1 at a predetermined scanning start position (a home position) relative to the jig 100 in the scanning direction, the user presses the print button 14 and moves the handheld printer 1 (manual scanning) in the scanning direction (X-axis direction) with the projection moving along the groove 110. With this action, ink droplets are discharged from the discharge nozzles 41a of the recording section 41 of the handheld printer 1 according to the drive waveform generated by the recording controller 56 of the handheld printer 1, and the letter image (e.g., the sender name) is printed with the ink at the center position (the target position) of the wrapping sheet P in the orthogonal direction.

According to the present embodiment, the jig 100 is set on the sheet such that one end (the reference portion) of the sheet in the direction orthogonal to the scanning direction is aligned with the sheet end indication 130 corresponding to the size of the sheet. With such setting, the groove 110 (the apparatus positioning reference) can be accurately aligned with one end (the reference portion) of the sheet in the direction orthogonal to the scanning direction. As the projection of the handheld printer 1 is inserted in the groove 110 of the jig 100 aligned with respect to the sheet, the handheld printer 1 is positioned with respect to the groove 110 in the direction orthogonal to the scanning direction. As a result, the handheld printer 1 is positioned, in the direction orthogonal to the scanning direction, with respect to one end of the sheet in the direction orthogonal to the scanning direction. As a result, in the direction orthogonal to the scanning direction, the image formation position at which the image is formed on the sheet coincides with the target position. Then, the user moves the handheld printer 1 (manual scanning) in the scanning direction (X-axis direction) in the state in which the position of the handheld printer 1 is regulated by the groove 110 of the jig 100 in the direction orthogonal to the scanning direction. Therefore, an image can be formed at the target position on the sheet with deviation in the Y-axis direction orthogonal to the scanning direction inhibited.

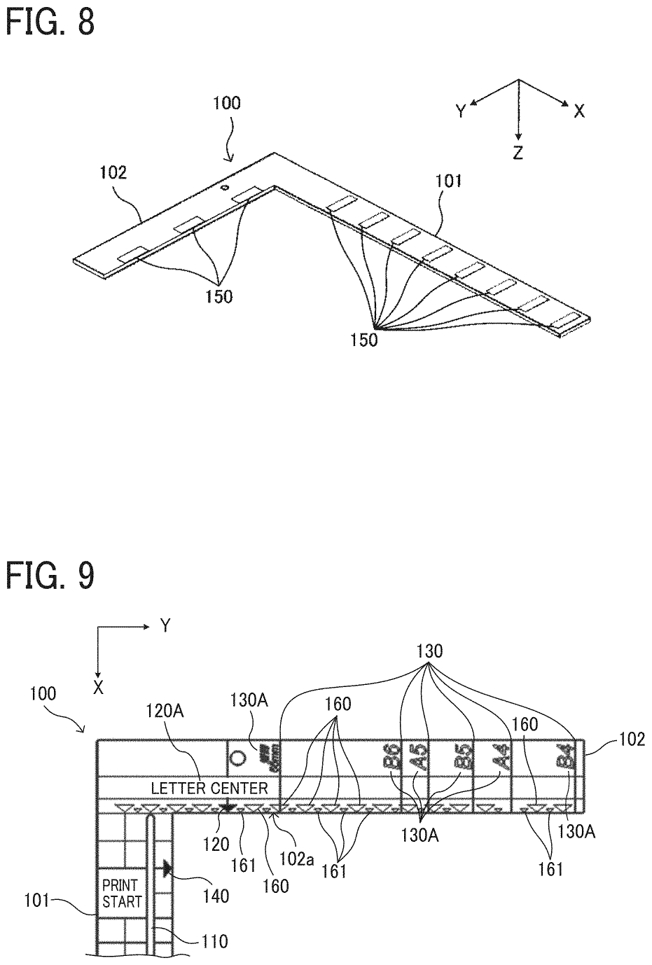

FIG. 8 is a perspective view illustrating the bottom face of the jig 100.

In the present embodiment, the bottom face of the jig 100 serves as a contact face to contact the front side of the sheet or a table on which the sheet is placed, and the contact face is provided with friction portions 150 made of a material higher in friction coefficient with the surface of the sheet or the table than the base of the jig 100. The friction portions 150 prevents slipping of the jig 100 on the surface of the table or the sheet and suppresses a relative displacement between the sheet and the jig 100.

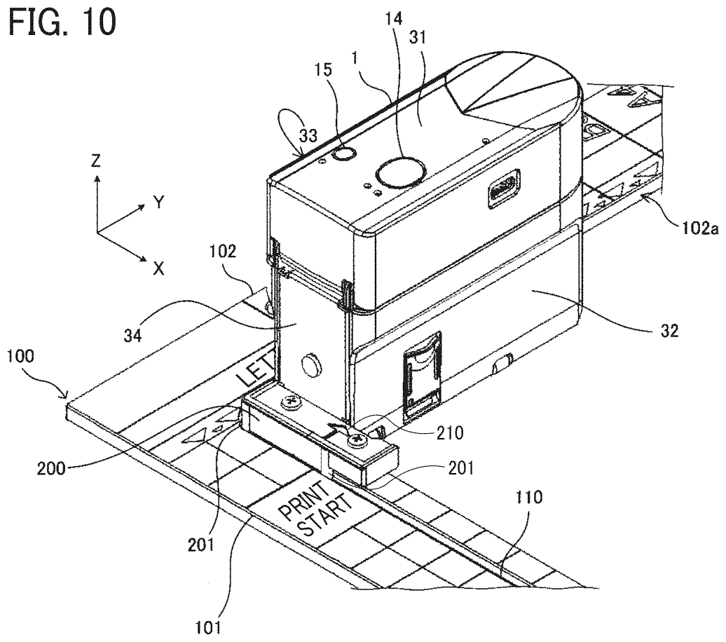

FIG. 9 is an enlarged view illustrating the sheet positioning member 102 of the jig 100.

The sheet end indications 130 on the sheet positioning member 102 of the jig 100 are line-like marks extending in the scanning direction (X-axis direction). The sheet end indications 130 according to the present embodiment are disposed at different positions in the orthogonal direction respectively corresponding to a plurality of predetermined sheet sizes, such as “strip 55 mm”, “B6”, “A5”, “B5”, “A4”, and “B4”. Each sheet end indication 130 is given a sheet size indication so that the user can distinguish the plurality of sheet end indications 130 for different sheet types (sizes). For example, size marks 130A, such as “A4” indicating a sheet size, are provided to the sheet end indications 130.

To the jig 100 according to the present embodiment, the various indications (marks) and the various indicators are given by printing such as resin printing, pasting of seals, processing on the base, or the like. In the case of printing or pasting, color-coding can be used according to types of indications, depending on the differences in the purpose of indications.

According to the present embodiment, the sheet positioning member 102 further includes an image formation position indicator 120. In a state in which the projection (e.g., a projection 201 in FIG. 10) of the handheld printer 1 is inserted in the groove 110, the image formation position indicator 120 indicates the position at which an image is formed by the handheld printer 1 in the orthogonal direction, thereby positioning the handheld printer 1 in the orthogonal direction. The image formation position indicator 120 is, for example, a triangular mark, or an arrow formed with a triangular mark and a line segment extending in the scanning direction. In the present embodiment, preferably, the jig 100 is provided with a mark so that the user can understand which part of the image to be formed is pointed by the image formation position indicator 120 in the direction orthogonal to the scanning direction. In the example illustrated in FIG. 9, the image formation position indicator 120 is provided with a letter image 120A (an indication) of “letter center”. This indication enables the user to recognize that the image formation position indicator 120 points at the center position of the image (the letter) to be formed in the direction orthogonal to the scanning direction.

Further, as illustrated in FIG. 9, the orthogonal-direction positioning member 101 according to the present embodiment includes an image formation start position indicator 140. When the handheld printer 1 is positioned at a predetermined scanning start position (home position) in the scanning direction, the image formation start position indicator 140 points at a start position of image formation on the recording medium by the handheld printer 1. With this structure, the user can grasp the position on the sheet at which the image formation starts in the scanning direction (X-axis direction) and the portion of the sheet in which the image is to be formed. In the present embodiment, the image formation start position indicator 140 is provided with a letter image (an indication) of “print start”. With the indication, the user can recognize that the arrow being the image formation start position indicator 140 points at the position at which the image formation starts.

FIG. 10 is a perspective view illustrating the handheld printer 1 positioned at the scanning start position (home position) in the scanning direction with respect to the jig 100. In the present embodiment, as the right side 33 of the handheld printer 1 is set in contact with an inner end face 102a (an end face on the lower side in FIG. 9) of the sheet positioning member 102 of the jig 100, the handheld printer 1 is positioned at the predetermined scanning start position (home position) in the scanning direction. The projection 201 (the inserted portion) is a portion of the attachment 200, which is a separate component attached to the handheld printer 1. At this time, if the projection 201 is set in the groove 110 of the jig 100, the image formation start position indicator 140 is hidden by the attachment 200 and is not visible to the user.

Therefore, in the present embodiment, the image formation start position indicator 210 is located on the attachment 200 of the handheld printer 1. In the example illustrated in FIG. 10, the image formation start position indicator 210 is an arrow marking, but the shape, the method of marking, and the like are not particularly limited. In the present embodiment, when the handheld printer 1 is set at the home position, the image formation start position indicator 140 of the jig 100 is located at the same position in the scanning direction as the image formation start position indicator 210 of the attachment 200 attached to the handheld printer 1.

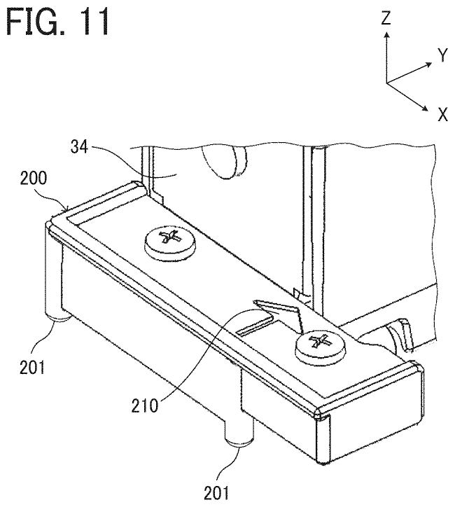

FIG. 11 is an enlarged view illustrating the attachment 200 attached to the handheld printer 1.

In the present embodiment, the projection 201 is provided to the attachment 200 attached to the handheld printer 1. The projection 201 is the inserted portion contacted by (abut on) the inner wall face of the groove 110 from both sides in the direction orthogonal to the scanning direction when the projection 201 is inserted in the groove 110 of the jig 100. Such contact restricts the displacement to both sides of the handheld printer 1 including the projection 201 in the direction orthogonal to the scanning direction.

In the present embodiment, a plurality of projections 201 is disposed at the same position in the direction orthogonal to the scanning direction and different positions from each other in the scanning direction. As the plurality of projections 201 enter the groove 110, the handheld printer 1 is inhibited from rotating around the Z-axis direction in FIG. 11, thereby stabilizing the posture of the handheld printer 1 when the handheld printer 1 is manually moved for scanning in the scanning direction (X-axis direction). Thus, high-quality images can be formed.

The projections 201 according to the present embodiment are provided to the attachment 200 removably attached to the handheld printer 1. When the image is formed by the handheld printer 1 without using the jig 100, the projections 201 are unnecessary. Accordingly, in this case, the attachment 200 can be removed from the handheld printer 1. That is, the attachment 200 according to the present embodiment is used together with the jig 100. The removable attachment 200 is advantageous as follows. In image formation with the handheld printer 1 without the jig 100, the attachment 200 can be removed from the handheld printer 1, thereby making the handheld printer 1 compact and facilitating the operation and handling of the handheld printer 1. In the present embodiment, the attachment 200 is not necessarily removable from the handheld printer 1.

Next, descriptions are given below of a procedure for forming a letter image with the handheld printer 1 using the jig 100. In the example described below, a sender name and an occasion type are printed at the center of the A4-sized wrapping sheet P in the direction orthogonal to the scanning direction.

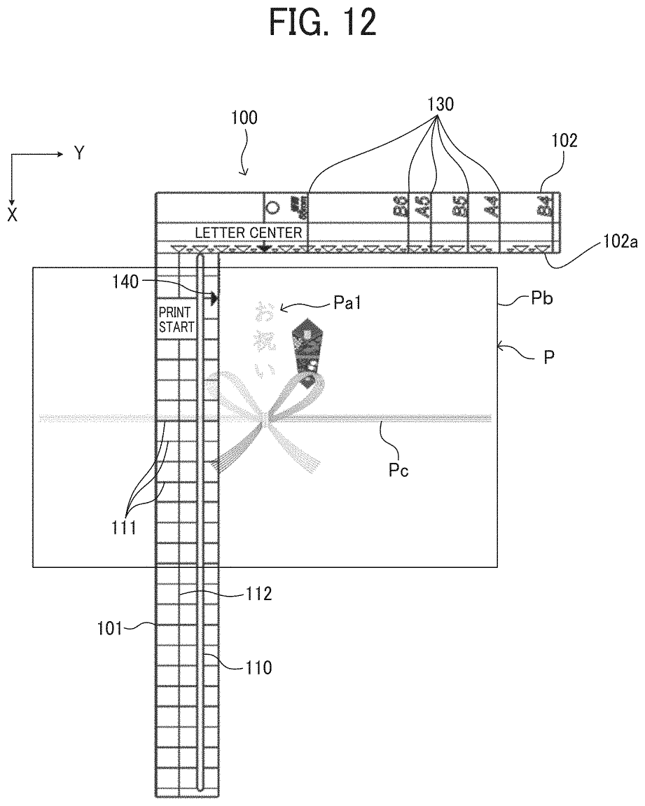

First, the user places the jig 100 on the wrapping sheet P, as illustrated in FIG. 12. In this example, a letter image Pa1 representing congratulations (the occasion type) is formed. The user adjusts the relative positions of the jig 100 and the wrapping sheet P so that an upper end (the image formation start position) of the letter image Pa1 to be formed matches the image formation start position indicator 140 in the scanning direction.

Further, the user adjusts the relative positions of the jig 100 and the wrapping sheet P so that the A4-size sheet end indication 130 on the sheet positioning member 102 of the jig 100 matches an end Pb of the wrapping sheet P in the direction orthogonal to the scanning direction. With such setting, in the orthogonal direction, the center position of the letter image Pa1 to be formed on the wrapping sheet P matches the position indicated by the image formation position indicator 120 on the sheet positioning member 102 of the jig 100.

Furthermore, the user adjusts the relative positions of the jig 100 and the wrapping sheet P such that the end Pb of the wrapping sheet P in the orthogonal direction is parallel to the scanning direction (X-axis direction). There are various methods of such adjustment. For example, a gift ribbon image Pc printed on the wrapping sheet P extends in the Y-axis direction orthogonal to the end Pb of the wrapping sheet P in the Y-axis direction.

Accordingly, the relative positions of the jig 100 and the wrapping sheet P can be adjusted so that the direction in which the gift ribbon image Pc extends parallel to the sheet reference line 111 on the orthogonal-direction positioning member 101 of the jig 100. Alternatively, one end (for example, the upper end in FIG. 12) of the wrapping sheet P in the scanning direction extends orthogonal to the end Pb of the wrapping sheet P in the Y-axis direction orthogonal to the scanning direction and the inner end face 102a of the sheet positioning member 102 of the jig 100 is parallel to the Y-axis direction. Therefore, the relative positions of the jig 100 and the wrapping sheet P can be adjusted so that the upper end of the wrapping sheet P parallels the inner end face 102a of the sheet positioning member 102 of the jig 100.

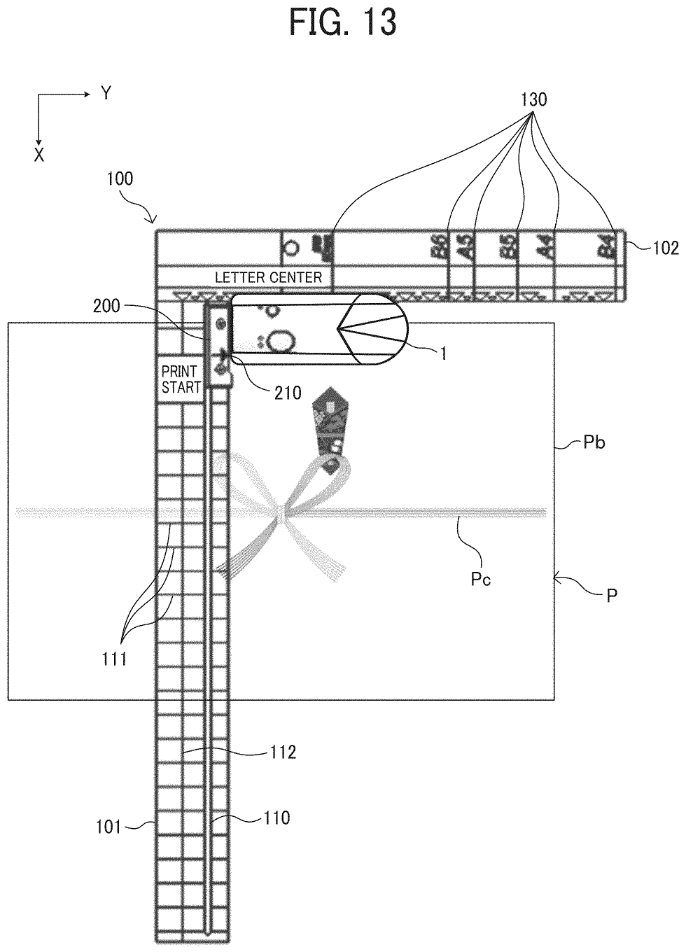

After thus adjusting the relative positions between the jig 100 and the wrapping sheet P, the user holds the jig 100 with one hand so that the jig 100 does not shift with respect to the wrapping sheet P and holds the handheld printer 1 with the other hand. As illustrated in FIG. 13, the user sets the handheld printer 1 on the jig 100 so that the projections 201 (see FIG. 11) of the attachment 200 of the handheld printer 1 enter the groove 110 in the orthogonal-direction positioning member 101 of the jig 100. As a result, the handheld printer 1 can move in the scanning direction (X-axis direction) while the position in the Y-axis direction orthogonal to the scanning direction is regulated.

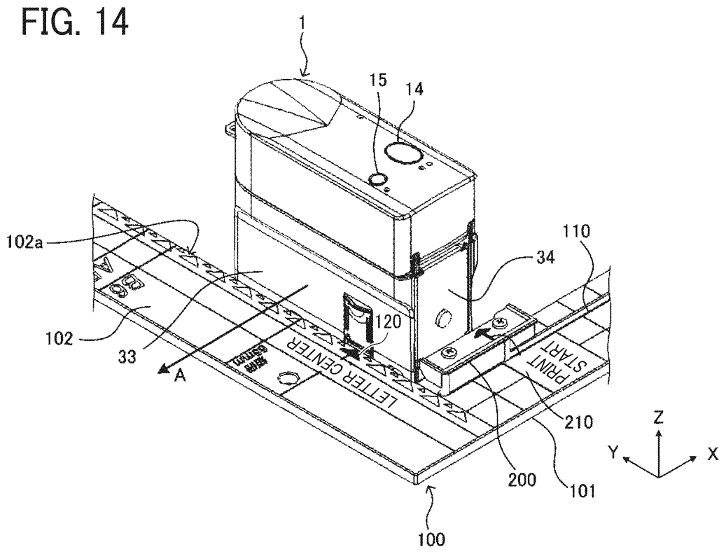

After thus setting the handheld printer 1 on the jig 100, the user moves the handheld printer 1 in the direction indicated by arrow A as illustrated in FIG. 14 so that the right side 33 of the handheld printer 1 abuts against the inner end face 102a (the lower end face in FIG. 9) of the sheet positioning member 102 of the jig 100. Then, the position of the handheld printer 1 in the scanning direction is determined at the predetermined scanning start position (home position). Hereinafter a position in the scanning direction is referred to as “scanning direction position”. That is, the inner end face 102a (the lower end face in FIG. 9) of the sheet positioning member 102 of the jig 100 serves as a scanning start positioning reference for setting the position of the handheld printer 1 at the scanning start position from which scanning with the handheld printer 1 is started.

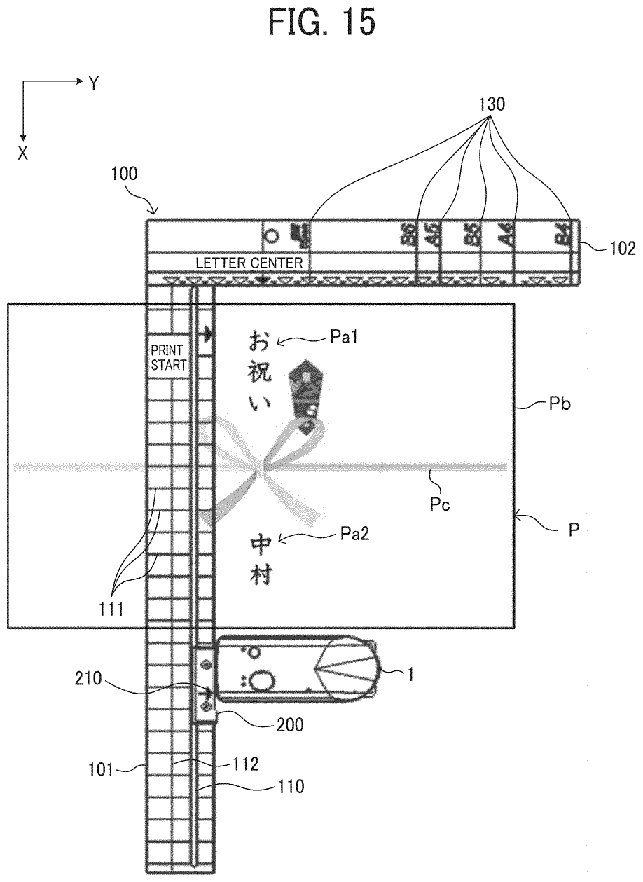

After the handheld printer 1 is set at the home position as described above, the user presses the print button 14 and moves the handheld printer 1 (manual scanning) in the scanning direction (X-axis direction) so that the projections 201 of the handheld printer 1 move along the grooves 110 of the jig 100. As a result, as illustrated in FIG. 15, the letter image Pa1 representing the occasion type (congratulations) and subsequently the letter image Pa2 representing the sender name are formed at the center (target position) of the wrapping sheet P in the Y-axis direction orthogonal to the scanning direction. In the case of images, such as the letter images Pa1 and Pa2, to be formed at the same position of the wrapping sheet P in the Y-axis direction orthogonal to the scanning direction as illustrated in FIG. 15, the images can be formed in one manual scanning.

Next, descriptions are given below of a procedure for forming an image with a plurality of times of manual scanning with the handheld printer 1 on one sheet, using the jig 100.

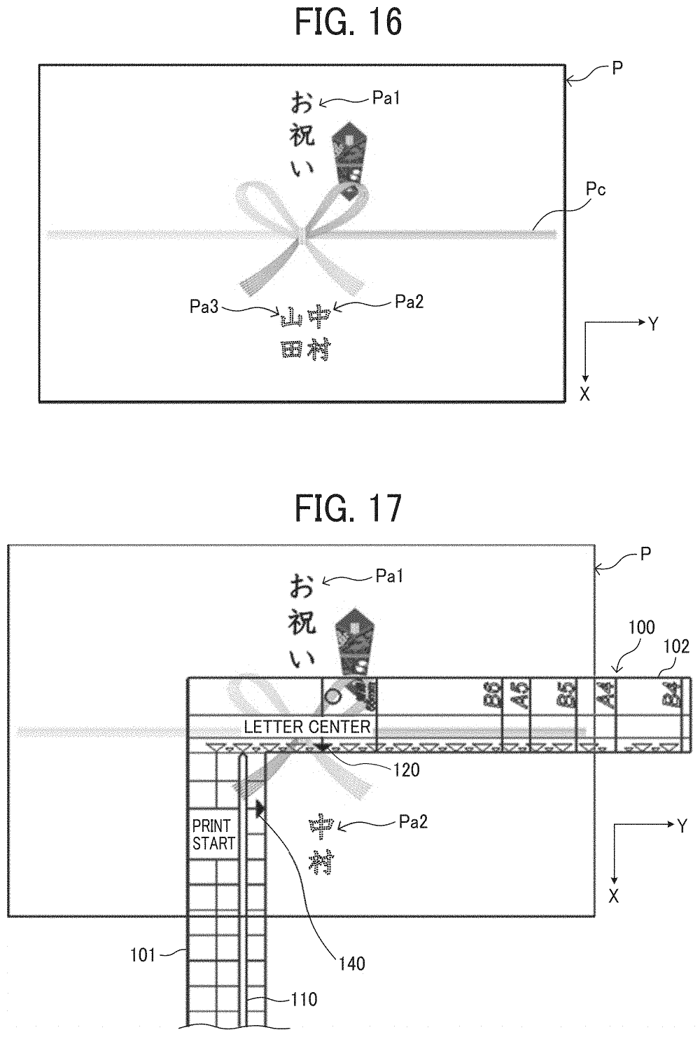

FIG. 16 illustrates the case where, after the letter image Pa1 representing the occasion type is formed on the wrapping sheet P, the letter images Pa2 and Pa3 representing names of two senders are formed in two lines in the Y-axis direction orthogonal to the scanning direction.

As illustrated in FIG. 16, both the letter images Pa2 and Pa3 representing the two sender names are to be formed at positions shifted from the center of the wrapping sheet P in the Y-axis direction orthogonal to the scanning direction. As described above, according to the present embodiment, the sheet end indications 130 are designed as follows. When the handheld printer 1 set at the home position is manually moved for scanning for image formation in a state in which the A4-sized sheet end indication 130 on the jig 100 is aligned with one end of the A4-sized wrapping sheet P in the direction orthogonal to the scanning direction, the image is formed with the image center positioned at the center of the wrapping sheet P in the direction orthogonal to the scanning direction. Therefore, if one end of the wrapping sheet P in the direction orthogonal to the scanning direction is aligned with the sheet end indication 130, the letter images Pa2 and Pa3 representing the two sender names are not formed at the respective target positions on the wrapping sheet P.

In such a case, after placing the jig 100 on the wrapping sheet P, as illustrated in FIG. 17, the user adjusts the relative positions between the jig 100 and the wrapping sheet P so that the upper end (the image formation start position) of each of the letter images Pa2 and Pa3 to be formed in two lines on the wrapping sheet P is aligned with the image formation start position indicator 140 in the scanning direction. In addition, as illustrated in FIG. 17, the user adjusts the relative positions between the jig 100 and the wrapping sheet P so that the image formation position indicator 120 on the sheet positioning member 102 of the jig 100 matches the target position image formation position (in the direction orthogonal to the scanning direction) of the letter image Pa2, which is one of the two letter images Pa2 and Pa3, to be formed on the wrapping sheet P in two lines.

Then, in the same manner as described above, the user adjusts the relative positions between the jig 100 and the wrapping sheet P such that the end Pb of the wrapping sheet P in the orthogonal direction is parallel to the scanning direction (X-axis direction), sets the handheld printer 1 relative to the jig 100 with the projections 201 (see FIG. 11) of the attachment 200 of the handheld printer 1 inserted in the groove 110 of the jig 100, and positions the handheld printer 1 at the predetermined scanning start position (home position) in the scanning direction. Then, the user presses the print button 14 and moves the handheld printer 1 (manual scanning) in the scanning direction (X-axis direction) so that the projections 201 of the handheld printer 1 move along the grooves 110 of the jig 100. Thus, the letter image Pa2 on the first line is formed at the target position of the wrapping sheet P.

After the letter image Pa2 representing the sender name on the first line is formed in this way, the user adjusts again the relative positions between the jig 100 and the wrapping sheet P to form the letter image Pa3 representing the sender name on the second line.

Further, the sheet positioning member 102 of the jig 100 according to the present embodiment includes line space indications 160 disposed at regular intervals from the image formation position indicator 120 in the Y-axis direction orthogonal to the scanning direction. Specifically, the line space indications 160 are disposed at intervals equivalent to one line space when an image of one line (e.g., the letter image Pa1, Pa2, or Pa3) is formed in one scanning. The line space indications 160 are respectively disposed at different positions in the Y-axis direction orthogonal to the scanning direction on the sheet positioning member 102. Providing the line space indications 160 on the jig 100 is advantageous when an image extending over a plurality of lines is formed. Since the user is given a guide for distance between lines, the image extending over a plurality of lines can be easily formed with constant line spaces.

The distance between the lines indicated by the line space indications 160 for determining the position in the orthogonal direction can be suitably set in accordance with the specifications of the handheld printer 1 (maximum image length formable by the handheld printer 1 in the orthogonal direction, etc.) or the manner of use by the user (letter image size used by the user). In the jig 100 according to the present embodiment, one line space is set to the length of the recording section 41 of the inkjet head 40 of the handheld printer 1 in the orthogonal direction, and the respective positions of the line space indications 160 in the orthogonal direction are determined accordingly. With such a configuration, when an image extending over a plurality of lines is formed with reference to the line space indications 160, overlapping of the adjacent lines in the image can be avoided.

In addition, setting the line space to the length of the recording section 41 in the orthogonal direction as described above is advantageous when a plurality of partial images extending over a plurality of lines is formed on a sheet with image formation of the maximum length in the orthogonal direction of the handheld printer 1 and combined into one image. In this case, deviations among the partial images in the orthogonal direction can be reduced, and the quality of the combined image can be high.

Further, in the jig 100 according to the present embodiment, auxiliary indications 161 smaller than the line space indications 160 are respectively disposed between the adjacent line space indications 160. This configuration is advantageous when the user wants to form an image extending over a plurality of lines with line spacing different from the line spacing indicated by the line space indication 160. The user can adjust the relative positions between the jig 100 and the wrapping sheet P with reference also to the auxiliary indication 161 so that the target line spacing is achieved. Therefore, even in the case of image formation over a plurality of lines with line spacing different from the spacing indicated by the line space indications 160, an image extending over a plurality of lines can be easily formed with constant line spacing.

Further, in the present embodiment, preferably, the line space indications 160 are different in form (shape, pattern, color, size, etc.) from the image formation position indicator 120 so that the user can easily distinguish the line space indications 160 from the image formation position indicator 120. In the present embodiment, the line space indications 160 are triangular marks similar to the image formation position indicator 120, but the color thereof is different from the color of the image formation position indicator 120. Specifically, for example, while the image formation position indicator 120 is black, the line space indications 160 are white.

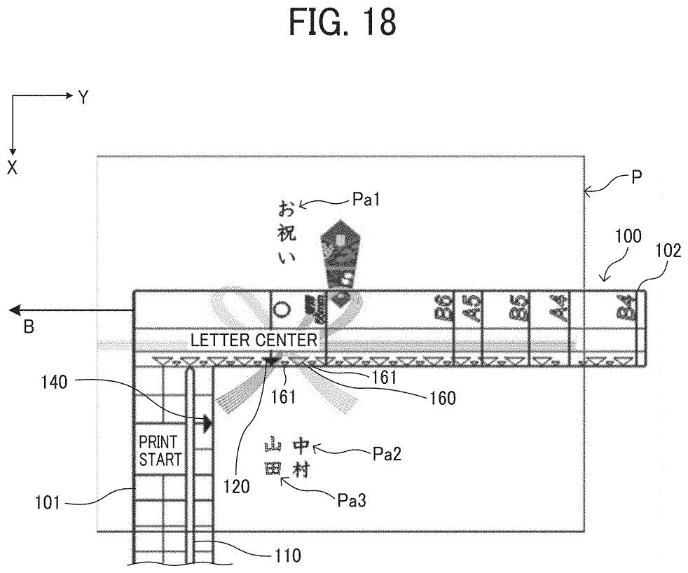

When the user forms the letter image Pa3 representing the sender name on the second line, the user adjusts again the relative positions between the jig 100 and the wrapping sheet P so that the center of the already-formed letter image Pa2 (the sender name on the first line) in the orthogonal direction is aligned with the position indicated by the line space indication 160 adjacent to the image formation position indicator 120. Specifically, the user moves the jig 100 in the direction indicated by arrow B in FIG. 18 with the wrapping sheet P fixed in position so that the center in the orthogonal direction of the letter image Pa2 representing the sender name on the first line matches the position indicated by the line space indication 160 next to the image formation position indicator 120. With this operation, as illustrated in FIG. 18, the relative positions between the jig 100 and the wrapping sheet P are adjusted so that the image formation position indicator 120 on the sheet positioning member 102 of the jig 100 matches the target position (in the orthogonal direction) at which the letter image Pa3 representing the sender name on the second line is to be formed on the wrapping sheet P.

Then, in the same manner as described above, the user sets again the handheld printer 1 relative to the jig 100, with the projections 201 (see FIG. 11) of the attachment 200 of the handheld printer 1 inserted in the groove 110 of the jig 100, and positions the handheld printer 1 at the predetermined scanning start position (home position) in the scanning direction. Then, the user presses the print button 14 and moves the handheld printer 1 (manual scanning) in the scanning direction (X-axis direction) so that the projections 201 of the handheld printer 1 move along the grooves 110 of the jig 100. Thus, the letter image Pa3 representing the sender name on the second line is formed at the target position on the wrapping sheet P.

Next, descriptions are given below in further detail of the image formation start position indicator 140 of the jig 100 according to the present embodiment.

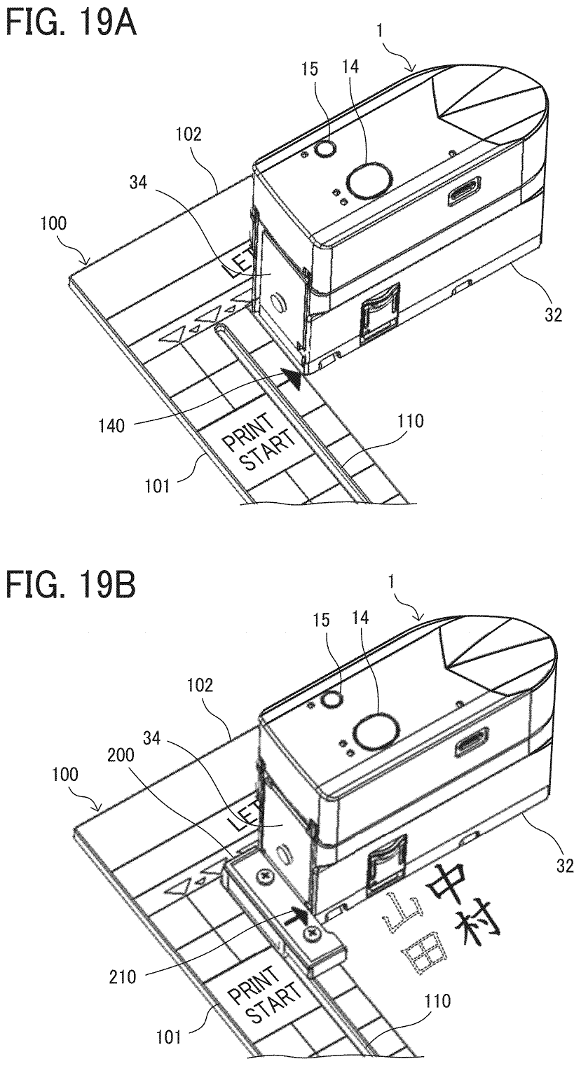

FIGS. 19A and 19B are perspective views of the handheld printer 1 being set at the home position in the scanning direction with respect to the jig 100. FIG. 19A illustrates the handheld printer 1 from which the attachment 200 is removed. FIG. 19B illustrates the handheld printer 1 with the attachment 200 attached thereto.

In the present embodiment, as described above, the orthogonal-direction positioning member 101 of the jig 100 is provided with the image formation start position indicator 140 that indicates the position on the recording medium in the scanning direction at which the handheld printer 1 starts image formation when the handheld printer 1 is positioned at the home position. The control board 57 of the handheld printer 1 according to the present embodiment is configured to control the handheld printer 1 to start image formation after the handheld printer 1 has moved by a specified distance in the scanning direction (hereinafter “specified distance before image formation”) after the print button 14 is pressed. The specified distance before image formation can be set freely. In the present embodiment, the specified distance before image formation is set to the distance from the exterior ridgeline of handheld printer 1 on the front side in the scanning direction at the home position, that is, the scanning direction position where the left side 32 of handheld printer 1 is located, to the recording section 41 of the handheld printer 1 at the home position (more specifically, the front end of the recording section 41 in the scanning direction). Accordingly, after the user starts moving the handheld printer 1 from the home position in the scanning direction, image formation is started at the position where the the front exterior ridgeline (the left side 32) of the handheld printer 1 has situated in the scanning direction when the handheld printer 1 is at the home position.

In the present embodiment, the jig 100 is provided with the image formation start position indicator 140. Accordingly, the jig 100 is positioned with respect to the sheet without setting the handheld printer 1 at the home position. Then, image formation can be started from the target image formation start position on the sheet. In addition, even if the user does not know that the image formation is started at the scanning direction position where the front exterior ridgeline (the left side 32) of the handheld printer 1 at the home position is located, the user can recognize the image formation start position, looking at the image formation start position indicator 140 on the jig 100.

Next, descriptions are given below of a procedure for forming an image with manual scanning with the handheld printer 1, on a sheet that is short (for example, a strip size) in the direction orthogonal to the scanning direction, using the jig 100.

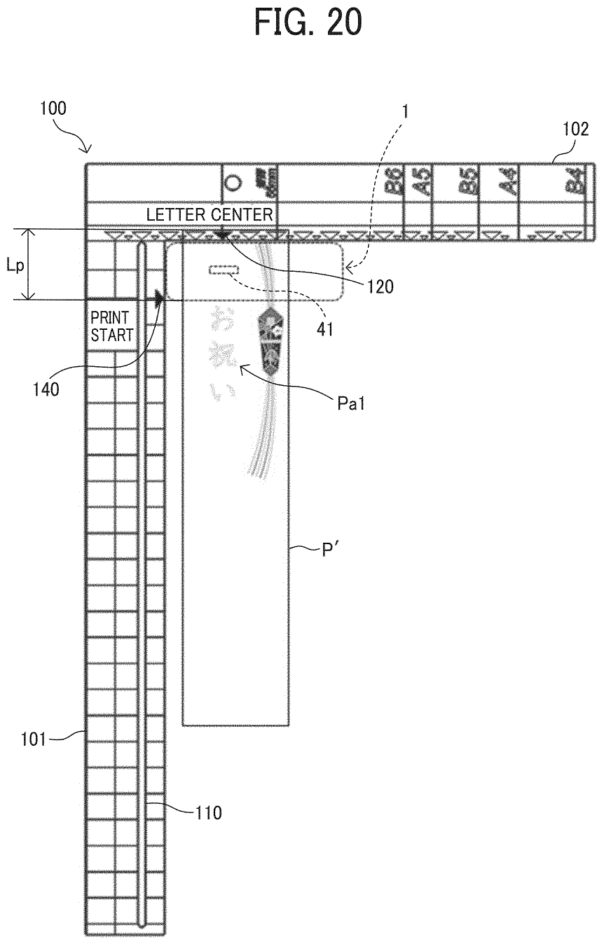

FIG. 20 is a perspective view illustrating a case of forming the letter image Pa1, representing congratulations, on a wrapping sheet P′ shaped like a strip.

If the sheet is long in the direction orthogonal to the scanning direction, one end of the sheet in the direction orthogonal to the scanning direction can be held by the orthogonal-direction positioning member 101 of the jig 100. Accordingly, there are no restrictions imposed in positioning of the sheet relative to the jig 100 in the scanning direction. Therefore, for example, image formation can be started from one end (the upper end in FIG. 20) of the sheet in the scanning direction.

However, the strip-shaped wrapping sheet P′ is short in the direction orthogonal to the scanning direction. Accordingly, the wrapping sheet P′ is not held by the orthogonal-direction positioning member 101 of the jig 100. Therefore, as illustrated in FIG. 20, it is necessary to press one end (the upper end in FIG. 20) of the wrapping sheet P′ in the scanning direction by the sheet positioning member 102 of the jig 100. Therefore, the positioning of the sheet with respect to the jig 100 in the scanning direction is executable only in one end portion (the upper end in FIG. 20) of the wrapping sheet P′, in the scanning direction, pressed by the sheet positioning member 102 of the jig 100. As a result, in the scanning direction, image formation is not feasible in an end portion of the wrapping sheet P′ extending from the end (the upper end in FIG. 20) pressed by the sheet positioning member 102 of the jig 100 to the image formation start position of the handheld printer 1 set at the home position. That is, a margin Lp is present on the wrapping sheet P′ as illustrated in FIG. 20.

To shorten the length of the margin Lp, a conceivable approach is setting the above-described specified distance before image formation (the distance by which the handheld printer 1 is moved in the scanning direction after the print button 14 is pressed). In this approach, the length of the margin Lp can be shortest in a case where the image formation is started simultaneously with the start of moving of the handheld printer 1 in the scanning direction from the home position (manual scanning) after pressing of the print button 14. In this case, image formation starts at the scanning direction position at which the recording section 41 of the handheld printer 1 is situated when the handheld printer 1 is positioned at the home position.

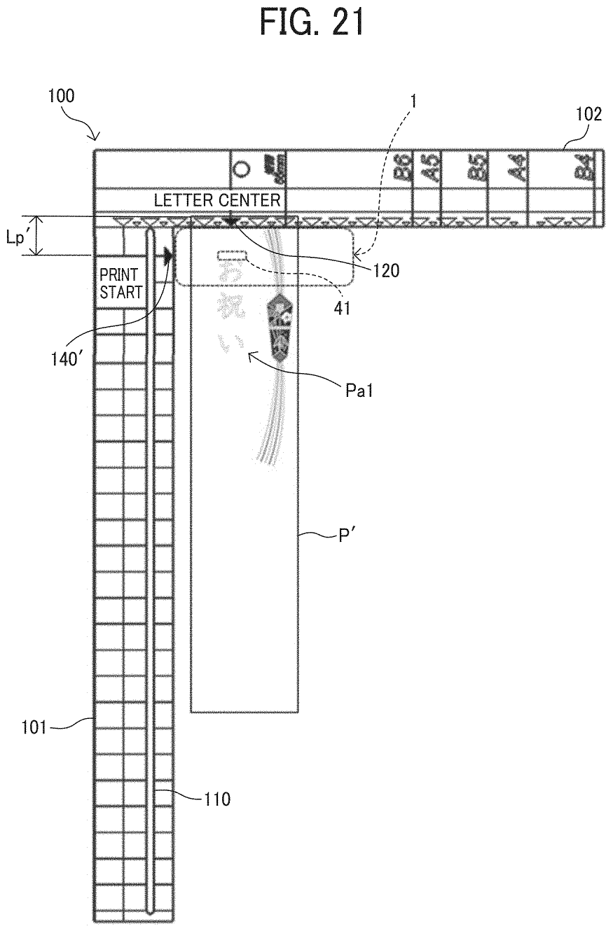

For the handheld printer 1 to operate in such a manner, an image formation start position indicator 140′ illustrated in FIG. 21 is provided on the orthogonal-direction positioning member 101 of the jig 100. That is, the image formation start position indicator 140′ is configured to point at the position of the recording section 41 of the handheld printer 1 at the predetermined scanning start position (home position) in the scanning direction. In this case, the length of the margin Lp′ can be reduced, and an image can be formed from a position closer to the end (the upper end in FIG. 21) of the wrapping sheet P′, even on the strip-shaped rectangular wrapping sheet P′, which is short in the direction orthogonal to the scanning direction.

The descriptions above concern the inkjet handheld printer 1, but aspects of the present disclosure can adapt to image forming apparatuses of other types. The aspects of the present disclosure can be applied to an image forming apparatus employing any suitable image formation method, such as, a thermal method or a thermal-transfer method.

The structures described above are examples, and aspects of the present disclosure provide respective effects as follows.

Aspect 1

Aspect 1 concerns a jig (for example, the jig 100) for a mobile image forming apparatus (for example, the handheld printer 1) that forms an image on a recording medium (for example, the wrapping sheet P) while being moved in a scanning direction (for example, the X-axis direction). The jig includes a first portion (for example, the orthogonal-direction positioning member 101) extending in a first direction aligned with the scanning direction, and a second portion (for example, the sheet positioning member 102) extending in a second direction orthogonal to the first direction. The first portion includes an apparatus positioning reference (for example, the groove 110) serving as a reference for positioning the image forming apparatus in the orthogonal direction (for example, the Y-axis direction) orthogonal to the scanning direction. Further, the second portion of the jig includes a jig positioning reference (for example, the sheet end indication 130) serving as a positioning reference for positioning the jig relative to the recording medium in the orthogonal direction.

According to this aspect, the jig for the image forming apparatus (also simply referred to as a “jig”) includes the jig positioning reference used as a reference in positioning the jig relative to the recording medium in the orthogonal direction. The jig is set on the recording medium so that the jig positioning reference is aligned with a predetermined reference portion on the recording medium (for example, one end of the recording medium in the orthogonal direction). With such setting, the apparatus positioning reference can be accurately positioned relative to the predetermined reference portion on the recording medium. Then, the position in the orthogonal direction (hereinafter “orthogonal direction position”) of the image forming apparatus (also simply referred to as “apparatus”) is set at the apparatus positioning reference that has been aligned in the orthogonal direction with the reference portion on the recording medium. Thus, in the state in which the orthogonal direction position of the apparatus is regulated, the apparatus is moved for scanning in the scanning direction. According to this aspect, the relative positions among the reference portion on the recording medium, the jig positioning reference for aligning with the reference portion, and the apparatus positioning reference are set so that the image formation position on the recording medium defined by such relative positions is set at the target position. With this setting, the image formation position can be accurately set at the target position on the recording medium in the orthogonal direction.

Aspect 2

According to Aspect 2, the jig positioning reference according to Aspect 1 includes a medium position indication (for example, the sheet end indication 130) that indicates the predetermined reference portion (for example, an end of the recording medium) on the recording medium in the orthogonal direction.

According to this aspect, the jig is set on the recording medium so that the jig positioning reference is aligned with the predetermined reference portion on the recording medium (for example, one end of the recording medium in the orthogonal direction). With such setting, the apparatus positioning reference can be accurately positioned relative to the predetermined reference portion on the recording medium.

Aspect 3

According to Aspect 3, the reference portion of the recording medium according to Aspect 2 is an end of the recording medium in the orthogonal direction.

According to this aspect, the user can easily align the jig positioning reference with the reference portion on the recording medium. Therefore, the orthogonal direction position of the image formation position can be accurately set at the target position on the recording medium.

Aspect 4

According to Aspect 4, in any one of Aspects 1 to 3, the jig positioning reference is disposed at each of a plurality of different positions different in distance from the apparatus positioning reference (for example, the groove 110) in the orthogonal direction.

Such a structure can correspond to a plurality of different sizes of recording media different in length in the orthogonal direction.

Aspect 5

According to Aspect 5, in Aspect 4, the different positions of the jig positioning references respectively correspond to different recording media sizes different from each other in orthogonal direction length, and the different positions are set such that an image is to be formed at an orthogonal direction center of the recording medium, when the jig is positioned with corresponding one of the jig positioning references aligned with the reference portion on the recording medium.

According to this aspect, when the user desires to form an image at the orthogonal direction center of the recording medium, the image formation position in the orthogonal direction can be accurately aligned with the target position on the recording medium.

Aspect 6

According to Aspect 6, the jig according to any one of Aspects 1 to 5 further includes an image formation position indicator (for example, the image formation position indicator 120) that indicates an orthogonal direction position at which an image is to be formed by the image forming apparatus in a state in which the orthogonal direction position of the image forming apparatus is determined by the apparatus positioning reference (for example, the groove 110).

According to this aspect, when the user tries to perform image formation at a target position on the recording medium in the direction orthogonal to the scanning direction, the user aligns the target position on the recording medium with the position indicated by the image formation position indicator. Accordingly, the image formation position can be set at the target position. Therefore, even if the recording medium has no reference portion, the image formation can be performed at the target position on the recording medium in the orthogonal direction.

Aspect 7

According to Aspect 7, the jig according to Aspect 6 further includes a line space indication (for example the line space indication 160) that indicates a position at one line space distance from the image formation position indicator in the direction orthogonal to the scanning direction, in a case where one line of the image (e.g., the letter image Pa1, Pa2, or Pa3) is formed in one scanning.

This structure facilitates formation of an image extending over a plurality of lines at regular line spacing.

Aspect 8

According to Aspect 8, in the jig according to Aspect 7, the line space indication has a different form from a form of the image formation position indicator.

With this structure, the user can easily distinguish the line space indication from the image formation position indicator. Accordingly, the user can be prevented from misidentifying such indications.

Aspect 9

According to Aspect 9, in the jig according to Aspect 7 or 8, the line space distance is set to a length of an image forming section (the recording section 41, i.e., the length of an array of the discharge nozzles 41a in FIG. 4) of the image forming apparatus in the orthogonal direction.

With such a configuration, when an image extending over a plurality of lines is formed with reference to the line space indications, overlapping of the adjacent lines in the image can be avoided. In addition, in the case where a plurality of partial images extending over a plurality of lines is formed and combined into one image on the recording medium, deviations among the partial images in the orthogonal direction can be reduced, and the quality of the combined image can be high.

Aspect 10

According to Aspect 10, the jig according to any one of Aspects 7 to 9 includes a plurality of line space indications (for example, the line space indications 160) corresponding to a plurality of lines, and further includes an auxiliary space indication (for example, the auxiliary indication 161) smaller in size than the plurality of line space indications and disposed between adjacent two of the plurality of line space indications.

With this structure, in a case of forming an image extending over a plurality of lines with desired line spacing different from the line spacing indicated by the line space indication, the user can set the jig on the recording medium with reference also to the auxiliary indication disposed between the line space indications so that the desired line spacing is achieved. Therefore, even in the case of image formation over a plurality of lines with line spacing different from the spacing indicated by the line space indications, an image extending over a plurality of lines can be easily formed with constant line spacing.

Aspect 11

According to Aspect 11, the jig according to any one of Aspects 1 to 10 further includes an image formation start position indicator (for example, the image formation start position indicator 140) that indicates a scanning direction position on the recording medium at which image formation by the image forming apparatus is started, when the image forming apparatus is positioned at a predetermined scanning start position (home position) in the scanning direction.

With this structure, the user can grasp, in advance, the position on the recording medium at which the image formation starts in the scanning direction and the portion of the recording medium in which the image is to be formed. Therefore, in the scanning direction, the image formation position can be accurately set at the target position on the recording medium.

Aspect 12

According to Aspect 12, in the jig according to Aspect 11, the image formation start position indicator indicates a position where the front end of the image forming apparatus in the scanning direction is located in a state in which the image forming apparatus is positioned at the scanning start position in the scanning direction.

With this structure, after setting the apparatus relative to the jig, the user can intuitively grasp the position on the recording medium at which the image formation starts in the scanning direction and the portion of the recording medium in which the image is to be formed.

Aspect 13

According to Aspect 13, in the jig according to Aspect 11, the image formation start position indicator indicates the scanning direction position of the image forming section (e.g., the recording section 41) when the image forming apparatus is positioned at the scanning start position in the scanning direction.

According to this aspect, the length of the margin (the portion in which the image is not to be formed) on the upstream side in the scanning direction can be further reduced.

Aspect 14

According to Aspect 14, the jig according to any one of Aspects 1 to 13 further includes a scanning start positioning reference (for example, the inner end face 102a of the sheet positioning member 102). With reference to the scanning start positioning reference, the image forming apparatus is positioned at the scanning start position at which scanning by the image forming apparatus is started.

According to this aspect, the apparatus can be accurately positioned at the predetermined scanning start position (home position) in the scanning direction. Therefore, the image formation position can be accurately set at the target position on the recording medium in the scanning direction.

Aspect 15

According to Aspect 15, the jig according to any one of Aspects 1 to 14 further includes a friction portion (for example, the friction portion 150) provided on a contact face to contact one of a face of a table on which the recording medium is placed and a surface of the recording medium. The friction portion increases a friction coefficient with the face of the table or the surface of the recording medium.

This aspect can inhibit the jig 100 from slipping on the recording medium or the table on which the recording medium is placed, and image formation with high positional accuracy can be performed more reliably.

Aspect 16

According to Aspect 16, the jig according to any one of Aspects 1 to 15 includes, at least one of, at least one orthogonal-direction reference line (for example, the sheet reference lines 111) extending along the orthogonal direction and at least one scanning-direction reference line (for example, the sheet reference lines 112) extending along the scanning direction.

According to this aspect, the jig can be set on the recording medium so that either a reference line segment on the recording medium extending in the scanning direction parallels the scanning-direction reference line of the jig, or a reference line segment on the recording medium extending in the orthogonal direction parallels the orthogonal-direction reference line. Such setting can inhibit askew image formation on the recording medium.

Aspect 17

According to Aspect 17, in any one of Aspects 1 to 16, the apparatus positioning reference (for example, the groove 110) contacts an inserted portion (for example, the projection 201) of the image forming apparatus, from both sides in the orthogonal direction, thereby regulating the position of the image forming apparatus in the direction orthogonal to the scanning direction.

According to this aspect, the displacements of the apparatus to not only one side but also both sides in the orthogonal direction are restricted. Accordingly, the user can easily move the apparatus straight in the scanning direction. Therefore, a higher quality image can be formed.

Aspect 18

According to Aspect 18, in Aspect 17, the apparatus positioning reference is a groove (for example, the groove 110) extending in the scanning direction to receive the inserted portion (for example, the projection 201) of the image forming apparatus.

According to this aspect, the straightness of the apparatus can be realized with a simple configuration.

Aspect 19 Aspect 19 concerns a mobile image forming system that includes a mobile image forming apparatus to form an image on a recording medium while manually moved in the scanning direction, and the jig according to any one of Aspects 1 to 18.

According to this aspect, the image formation position can be accurately aligned with the target position on the recording medium in the orthogonal direction.

Aspect 20

Aspect 20 concerns a jig set for a mobile image forming apparatus. The jig set includes the jig according Aspect 17 or 18 and an attachment (for example, the attachment 200) to be attached to the image forming apparatus. The attachment provides the inserted portion when the attachment is attached to the image forming apparatus.

According to this aspect, by attaching the attachment including the inserted portion to an existing apparatus, the image formation position can be accurately aligned with the target position on the recording medium in the orthogonal direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A jig for an image forming apparatus that forms an image on a recording medium while being moved in a scanning direction, the jig comprising:
a first portion extending in a first direction to be aligned with the scanning direction, the first portion including an apparatus positioning reference extending in the first direction, the apparatus positioning reference being a reference in positioning the image forming apparatus in an orthogonal direction orthogonal to the scanning direction; and
a second portion extending in a second direction orthogonal to the first direction, the second portion including a jig positioning reference being a reference in positioning the jig relative to the recording medium in the orthogonal direction.

2. The jig according to claim 1,
wherein the jig positioning reference includes a medium position indication configured to indicate a reference portion on the recording medium in the orthogonal direction.

3. The jig according to claim 2,
wherein the reference portion on the recording medium is an end of the recording medium in the orthogonal direction.

4. The jig according to claim 1,
wherein the jig positioning reference is disposed at each of a plurality of different positions different in distance from the apparatus positioning reference in the orthogonal direction.

5. The jig according to claim 4,
wherein the plurality of different positions corresponds to different recording media sizes different from each other in length in the orthogonal direction, and
wherein a distance from each of the plurality of different positions to an image formation position on the second portion is a half of corresponding one of the different recording media sizes in the orthogonal direction, the image formation position determined by the apparatus positioning reference.

6. The jig according to claim 1, further comprising an image formation position indicator configured to indicate an image formation position in the orthogonal direction at which an image is to be formed by the image forming apparatus being positioned with reference to the apparatus positioning reference.

7. The jig according to claim 6,
wherein the second portion further includes at least one line space indication disposed at an interval from the image formation position indicator in the orthogonal direction, the interval equivalent to one line space distance in a case where an image of one line is formed in one scanning.

8. The jig according to claim 7,
wherein the at least one line space indication has a different form from a form of the image formation position indicator.

9. The jig according to claim 7,
wherein the one line space distance is set to a length of an image forming section of the image forming apparatus in the orthogonal direction.

10. The jig according to claim 7,
wherein the at least one line space indication includes a plurality of line space indications corresponding to a plurality of lines; and
wherein the second portion further includes a plurality of auxiliary indications smaller in size than the plurality of line space indications and respectively disposed between adjacent two of the plurality of line space indications.

11. The jig according to claim 1, further comprising an image formation start position indicator configured to indicate an image formation start position on the recording medium in the scanning direction, the image formation start position at which image formation by the image forming apparatus is started in a state in which the image forming apparatus is positioned at a predetermined scanning start position in the scanning direction.

12. The jig according to claim 11,
wherein the image formation start position is a position where a front end of the image forming apparatus in the scanning direction is located in a state in which the image forming apparatus is positioned at the predetermined scanning start position in the scanning direction.

13. The jig according to claim 11,
wherein the image formation start position is a position where an image forming section of the image forming apparatus is located in a state in which the image forming apparatus is positioned at the predetermined scanning start position in the scanning direction.

14. The jig according to claim 1, further includes a scanning start positioning reference configured to set the image forming apparatus at a predetermined scanning start position in the scanning direction, the predetermined scanning start position from which the image forming apparatus starts scanning in the scanning direction.

15. The jig according to claim 1, further comprising a friction portion disposed on a contact face of the jig to contact one of a surface of the recording medium and a face of a table on which the recording medium is placed, the friction portion made of a material higher in a friction coefficient with the one of the surface of the recording medium and the face of the table than the contact face of the jig.

16. The jig according to claim 1, further comprising, at least one of:
at least one orthogonal-direction reference line extending along the orthogonal direction; and
at least one scanning-direction reference line extending along the scanning direction.

17. The jig according to claim 1,
wherein the apparatus positioning reference is configured to contact an inserted portion of the image forming apparatus, from both sides in the orthogonal direction, to regulate the position of the image forming apparatus in the orthogonal direction.

18. The jig according to claim 17,
wherein the apparatus positioning reference is a groove extending in the first direction to be aligned with the scanning direction, the groove configured to receive the inserted portion of the image forming apparatus.

19. A jig set for an image forming apparatus, the jig set comprising:
the jig according to claim 17; and
an attachment to be attached to the image forming apparatus, the attachment including the inserted portion.

20. An image forming system comprising:
an image forming apparatus configured to form an image on a recording medium while being moved in a scanning direction; and
the jig according to claim 1, to position the image forming apparatus.
